(19) United States
(12) Patent Application Publication
(10) Pub. No.: US 2011/0026481 A1
(43) Pub. Date: Feb. 3, 2011

(54) WIRELESS COMMUNICATION METHOD AND WIRELESS COMMUNICATION SYSTEM

(75) Inventor: Nobuaki TAKAMATSU, Kanagawa (JP)

Correspondence Address: Studebaker & Brackett PC, One Fountain Square, 11911 Freedom Drive, Suite 750, Reston, VA, 20190, US

(73) Assignee: KYOCERA CORPORATION, Kyoto (JP)

(21) Appl. No.: 12/934,840

(22) PCT Filed: Mar. 26, 2009
(86) PCT No.: PCT/JP2009/056180

§ 371 Date: Sep. 27, 2010

(30) Foreign Application Priority Data
Mar. 28, 2008 (JP) 2008-085142

(51) Int. Cl. H04W 72/04; H04B 7/208; H04J 3/00

(52) U.S. Cl. 370/329; 370/344

(57) ABSTRACT

One object of the present inventions is to improve efficiency and stability of wireless communication by performing carrier sense in advance at appropriate timing and completing a switching process of an anchor channel within a short time period. In the wireless communication system 100 of the present invention, if the base station 120 detects that the communication quality of an anchor channel becomes a first threshold value or lower, the base station 120 extracts through carrier sense one or more of switching channel candidates capable of performing wireless communication with the PHS terminal 110, and the PHS terminal performs carrier sense for the switching channel candidates and selects a switching channel capable of performing wireless communication with the base station in advance. Thus, even if the communication quality of the anchor channel becomes a second threshold value lower than a first threshold value, switching to the switching channel can be quickly performed. Accordingly, it is possible to complete switching process within a short time period.

### TECHNICAL FIELD

The present invention relates to a wireless communication method and a wireless communication system which switch assignment of a control channel for transmitting control information according to deterioration of communication quality of the control channel in a wireless communication using an OFDMA system.

### BACKGROUND ART

Recently, a mobile station such as a PHS (Personal Handy phone System), a portable telephone, and the like are widely used, and a telephone call or access to information becomes available irrespective of time and place. Nowadays, particularly, the amount of available information is ever increasing. In order to download a large amount of data, a high-speed and high-quality wireless communication method has been employed.

For example, as a standard for next-generation PHS communication capable of performing high-speed digital communication, ARIB (Association of Radio Industries and Businesses) STD T95 and PHS MoU (Memorandum of Understanding) (A-GN4. 00-01-TS Rev. 3 “Next Generation PHS Specifications”) are known. In such communication, an OFDM (Orthogonal Frequency Division Multiplexing) system is employed. The OFDM system is classified as one category of a multiplexing system and uses a plurality of carrier waves on a unit time axis, and frequency bands of the carrier waves are partly overlapped with one another so that, in adjacent carrier waves, the phases of signal waves to be modulated are orthogonal to each other, whereby the frequency band is effectively used.

While OFDM assigns sub-channels by time division to individual users, there is also provided OFDMA (Orthogonal Frequency Division Multiplexing Access), which allows a plurality of users to share all sub-channels and assigns sub-channels having the highest transmission efficiency to each user.

In ARIB STD T95 or PHS MoU, data to be transmitted and received are divided in frame units, and a frame is composed of a plurality of PRUs (Physical Resource Unit) in FM-mode (Fast access channel based on Map-Mode). Control information such as MCS (Modulation and Coding Scheme) used in adaptive modulation, a map of a communication channel, or error information is exchanged between a mobile station and a base station through an anchor channel (ANCH) (control channel) occupying one PRU. The anchor channel including this important control information is preferentially assigned with PRU having higher communication quality than an extra channel simply used as a data communication path.

However, there is a case where communication quality of the PRU to which the anchor channel has been assigned is deteriorated due to changes in communication environment such as movement of a mobile station or signal interference. When deterioration of the anchor channel is detected, a base station performs so-called anchor channel switching to switch the anchor channel to PRU having good communication quality. In the above-described next-generation PHS communication standard, switching of an anchor channel is performed as described below.

FIG. 10 is a flow chart showing a process of switching channel assignment of an anchor channel in a related-art technology. A mobile station performs communication through an anchor channel assigned to a channel designated by SCCH (Signaling Control Channel) from a base station and an extra channel designated through the anchor channel (S10). Here, if the base station detects deterioration of communication quality of the anchor channel (S12), the base station performs carrier sense to select a channel which provides highest communication quality (S14). Then, the base station transmits channel switching instruction including the selected channel to the mobile station, through EDCH (EXCH Data Channel) (S16).

In the base station, count of a base station response confirmation timer is started at the same time as the transmission of the channel switching instruction (S18). When there is no response to the channel switching instruction from the mobile station, the base station response confirmation timer is in time out to stop the channel switching process and continue the communication through the previous channel.

Upon receiving the channel switching instruction, the mobile station starts count of a mobile station response confirmation timer (S20) similarly to the base station response confirmation timer, and performs carrier sense for the channel included in the channel switching instruction in response to the channel switching instruction (S22). If the channel is capable of performing communication, the mobile station starts uplink transmission of the channel as a new anchor channel together with the previous anchor channel (S24). In this case, control signals are identical. If it is detected through carrier sense that the channel is not capable of performing communication, the mobile station performs a channel retransmission request to the base station.

Upon receiving the control channel of the new anchor channel and the previous anchor channel, similarly to the mobile station, the base station starts downlink transmission through the new anchor channel and the previous anchor channel (S26). In this case, control signals are also identical.

Upon receiving the downlink control signals of the new anchor channel and the previous anchor channel, the mobile station concludes that downlink synchronization has been established and stops the mobile station response confirmation timer (S28). And, the mobile station disconnects and opens the previous anchor channel (S30) and transmits that information to the base station (S32).

Upon receiving the information, the base station concludes that uplink synchronization has been established and stops the base station response confirmation timer (S34). And, the base station disconnects and opens the previous channel (S36). In this way, communication through the new anchor channel is established (S38).

### DISCLOSURE OF THE INVENTION

### Problem to be Solved by the Invention

However, in the above-described anchor channel switching, a long time period (for example, more than 5 frames) is required from the base station detects deterioration of communication quality until the channel is completely switched (indicated by a two-direction bold arrow in the drawings). Even during the anchor channel switching process, it is possible to independently perform transmitting and receiving general data. However, since data transmitting and receiving are performed based on the anchor channel having deteriorated communication quality, the communication environment is not desirable.

One of the reasons why time is required to switch the anchor channel can be the time occupied by carrier sense. Thus, it may be considered that the base station and the mobile station always perform carrier sense to prepare a usable channel in advance. However, processing load in the mobile station is excessively increased. Further, there is the problem that no substantial merits can be obtained, compared to excessive power consumption.

In addition, in the anchor channel switching, since the base station detects deterioration of communication quality as shown in FIG. 10, even if communication quality in the mobile station is deteriorated, there is no means to request anchor channel switching from the mobile station.

In view of the above problem, one object of the present invention is to provide a wireless communication method and a wireless communication system which are capable of improving efficiency and stability of wireless communication by performing carrier sense in advance at appropriate timing and completing a switching process of an anchor channel within a short time period, without departing from a standard.

### Means to Solve the Technical Problem

In order to solve the above problem, according to an aspect of the preset invention, there is provide a wireless communication method of switching assignment of a control channel for transmitting control information according to deterioration of communication quality of the control channel, in a wireless communication system including a mobile station and a base station performing wireless communication with the mobile station based on an OFDMA system. The method includes: the base station extracting through carrier sense one or more of switching channel candidates capable of performing wireless communication with the mobile station if the communication quality of the control channel becomes a first threshold value or lower; the base station transmitting a switching channel selection instruction including the switching channel candidates to the mobile station; the mobile station performing carrier sense for the one or more of switching channel candidates in response to the switching channel selection instruction from the base station; the mobile station transmitting a selection response including a switching channel capable of performing wireless communication with the base station, to the base station; the base station receiving the selection response from the mobile station and holding the switching channel included in the selection response; the base station transmitting a channel switching instruction to switch the control channel to the switching channel, to the mobile station if the communication quality of the control channel becomes a second threshold value or lower, which is lower than the first threshold value; and the mobile station switching the control channel to the switching channel in response to the channel switching instruction from the base station.

In the present invention, a switching destination candidate (switching channel) of a control channel is selected at the time when the communication quality becomes the first threshold value or lower, which is a prior stage of the second threshold value requiring switching of the control channel. If the communication quality becomes the second threshold value or lower, the control channel can be immediately switched.

Accordingly, carrier sense is performed at non-congested (always or periodical) appropriate timing, and thereby inhibiting increase of processing load or consumed power and completing the switching process of the control channel within a short time period. In addition, a new control channel is established earlier, so that efficiency and stability of wireless communication can be improved.

In addition, in selecting a switching channel, the base station can extract a plurality of switching channel candidates capable of performing wireless communication, and among them, the mobile station can select a switching channel. Thus, compared to conventional technology, in which a mobile station determines whether or not to adopt one channel selected by a base station, the chance to select an appropriate switching channel is greatly increased.

According to another aspect of the present invention, there is provided a wireless communication method of switching assignment of a control channel for transmitting control information according to deterioration of communication quality of the control channel, in a wireless communication system including a mobile station and a base station performing wireless communication with the mobile station based on an OFDMA system. The method includes: the mobile station extracting through carrier sense one or more of switching channel candidates capable of performing wireless communication with the base station if the communication quality of the control channel becomes a first threshold value or lower; the mobile station transmitting a switching channel selection instruction including the one or more of switching channel candidates to the base station; the base station performing carrier sense for the switching channel candidates in response to the switching channel selection instruction from the mobile station, and holding a channel capable of performing wireless communication with the mobile station as a switching channel; the mobile station transmitting a request for channel switching of the control channel to the base station if the communication quality of the control channel becomes a second threshold value or lower, which is lower than the first threshold value; the base station transmitting a channel switching instruction to switch the control channel to the switching channel to the mobile station in response to the channel switching request; and the mobile station switching the control channel to the switching channel in response to the channel switching instruction from the base station.

In the above invention, the base station detects deterioration of the communication quality. However, in the present invention, the mobile station detects deterioration of the communication quality. Since a node itself, which detects deterioration of the communication quality, can start preparation for switching of the control channel, a node having poor communication quality, namely, a node actually requiring control channel switching can pull the trigger.

According to a further aspect of the present invention, there is provided a wireless communication system includes: a mobile station; and a base station performing wireless communication with the mobile station based on an OFDMA system, and the wireless communication system being configured to switch assignment of a control channel according to deterioration of communication quality of the control channel. The base station includes: a channel extraction unit which extracts through carrier sense one or more of switching channel candidates capable of performing wireless communication with the mobile station if the communication quality of the control channel becomes a first threshold value or lower; a selection instruction transmission unit which transmits a switching channel selection instruction including the one or more of switching channel candidates, to the base station; a channel holding unit which receives a selection response from the mobile station and holds a switching channel included in the selection response; and a switching instruction transmission unit which transmits a channel switching instruction to switch the control channel to the switching channel, to the mobile station if the communication quality of the control channel becomes a second threshold value or lower, which is lower than the first threshold value. The mobile station includes: a channel selection unit which performs carrier sense for the switching channel candidates in response to the switching channel selection instruction from the base station and transmits the selection response including the switching channel capable of performing wireless communication with the base station, to the base station; and a channel switching performing unit which switches the control channel to the switching channel in response to the channel switching instruction from the base station.

According to a further aspect of the present invention, there is provided a wireless communication system including: a mobile station; and a base station performing wireless communication with the mobile station based on an OFDMA system, and the wireless communication system being configured to switch assignment of a control channel according to deterioration of communication quality of the control channel. The mobile station includes: a channel extraction unit which extracts through carrier sense one or more of switching channel candidates capable of performing wireless communication with the base station if the communication quality of the control channel becomes a first threshold value or lower; a selection instruction transmission unit which transmits a switching channel selection instruction including the switching channel candidates to the base station; a switching request transmission unit which transmits a request for channel switching of the control channel, to the base station if the communication quality of the control channel becomes a second threshold value or lower, which is lower than the first threshold value; and a channel switching performing unit which switches the control channel to the switching channel included in the channel switching instruction in response to the channel switching instruction from the base station. The base station includes: a channel holding unit which performing carrier sense for the switching channel candidates in response to the switching channel selection instruction from the mobile station, and holds a channel capable of performing wireless communication with the mobile station, as the switching channel, and a switching instruction transmission unit which transmits a channel switching instruction to switch the control channel to the switching channel to the mobile station in response to the request for channel switching.

The components or the descriptions thereof, which correspond to the technical concept of the wireless communication method described above, are applicable to the corresponding wireless communication system.

The base station may further include a valid timer for determining a lapse of valid time of the switching channel held in the channel holding unit.

According to this configuration, a valid time period can be provided for the selected switching channel, and if the communication quality continues to be the first threshold value or lower even after time-out of the valid timer, it is possible to select an optimum switching channel at that time once again. Thus, an actually available switching channel can be continuously renewed, irrespective of changes in wireless wave environment.

Meanwhile, if the mobile station and the basic station perform wireless communication based on PHS MoU using an OFDMA system, the control channel may be an anchor channel. In addition, the switching channel selection instruction, the selection response, the channel switching request, or the channel switching instruction may be transmitted through an extra channel.

The extra channel also has an area including this control signal. The above-described control signal is transmitted by using the area, so that it is possible to quickly and completely switch the anchor channel without disturbing the control signal of the anchor channel.

### Effect of the Invention

In the above-described wireless communication system of the present invention, without departing from standards, carrier sense is performed in advance at appropriate timing, and thereby completing a switching process of a control channel within a short time period, so that efficiency and stability of wireless communication can be improved.

### BRIEF DESCRIPTION OF DRAWINGS

FIG. 1 is a view for explaining general connection relation of a wireless communication system according to a first embodiment.

FIG. 2 is a view for explaining frame configuration of data to be transmitted and received in PHS MoU.

FIG. 3 is a block diagram showing general configuration of a base station.

FIG. 4 is a functional block diagram showing hardware configuration of a PHS terminal.

FIG. 5 is a perspective view showing appearance of a PHS terminal.

FIG. 6 is a sequence view showing a flow of processes of a wireless communication method.

FIG. 7 is a block diagram showing general configuration of a PHS terminal according to a second embodiment.

FIG. 8 is a block diagram showing general configuration of a base station.

FIG. 9 is a sequence view showing a flow of processes of a wireless communication method.

FIG. 10 is a flow chart showing a related-art process of switching channel assignment of an anchor channel.

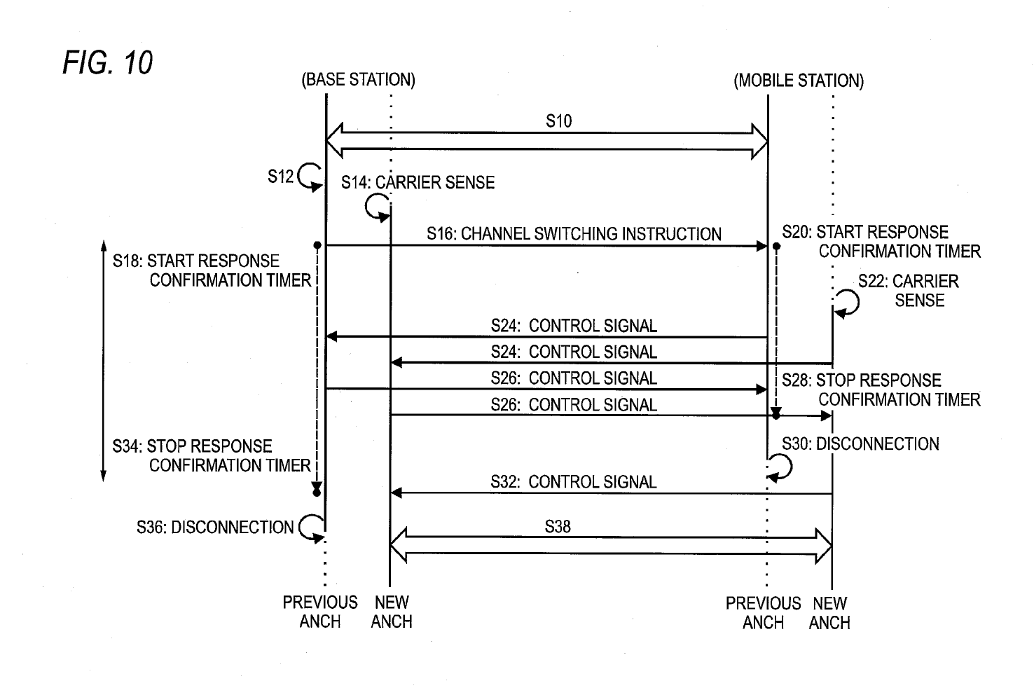

### DESCRIPTION OF REFERENCE NUMERALS

100: wireless communication system

110: PHS terminal (mobile station)

120: base station

180: anchor channel

230: channel extraction unit

232: selection instruction transmission unit

234: channel holding unit

236: valid timer

238: switching instruction transmission unit

330: channel section unit

332: channel switching performing unit

334: terminal response confirmation timer

512: switching request transmission unit

### BEST MODE FOR CARRYING OUT THE INVENTION

Hereinafter, a preferable embodiment of the present invention will be described in detail with reference to the accompanying drawings. In such an embodiment, dimensions, materials, and other particular numerical values, etc., are merely exemplary to facilitate understanding of the invention and should not be construed as limiting the present invention thereto unless otherwise expressly described herein. Meanwhile, in this specification and the drawings, components having substantially the same functions and configurations are denoted by the same reference numeral to omit repeated explanation, and components having no direct relation with the present invention are not illustrated.

A mobile station, which is represented by a PHS terminal, a portable telephone, or the like, and a base station, which is fixedly provided with certain intervals, configure a wireless communication system for performing wireless communication. In this embodiment, for easy understanding, a wireless communication system will first be described as a whole, and thereafter, detailed configuration of a base station and a PHS terminal as a mobile station will be described. Although this embodiment describes a PHS terminal as an example of a mobile station, the mobile station is not limited thereto and may include various electronic devices capable of performing wireless communication, such as portable telephones, laptop personal computers, PDAs (Personal Digital Assistant), digital cameras, music players, car navigators, portable televisions, game devices, DVD players, and remote controllers.

(First Embodiment: Wireless Communication System 100)

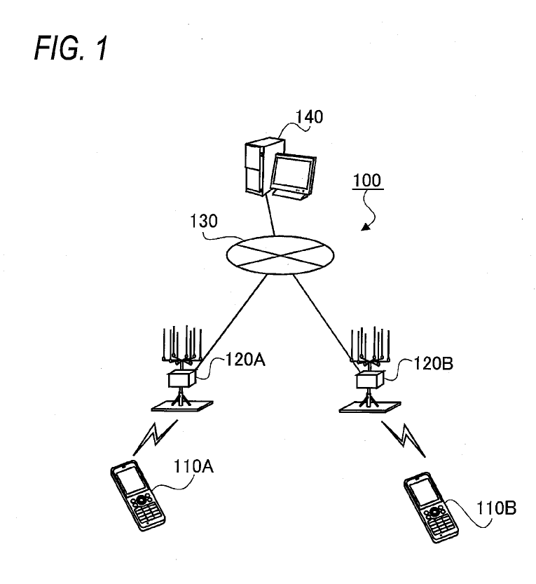

FIG. 1 is a view showing general connection relation of the wireless communication system 100. The wireless communication system 100 includes PHS terminals 110 (110A, 110B), base stations 120 (120A, 120B), a communication network 130 including an ISDN (Integrated Services Digital Network) line, Internet, and a private line, and the like, and a relay server 140.

In the wireless communication system 100, when a user makes an access from a user's PHS terminal 110A to the other PHS terminal 110B through a communication line, the PHS terminal 110A makes a request for wireless connection to the base station 120A, which exists within communication coverage. Upon receiving the request for wireless access, the base station 120A makes a request for communication connection to a communication counterpart to the relay server 140 through the communication network 130. The relay server 140 selects, for example, the base station 120B, which exists within wireless communication coverage, with reference to location registration information of the other PHS terminal 110B, and thereby securing a communication path between the base station 120A and the base station 120B to establish communication between the PHS terminal 110A and the PHS terminal 110B.

In this wireless communication system 100, various techniques to improve communication speed and communication quality of the PHS terminals 110 and the base stations 120 have been employed. In this embodiment, for example, the next generation PHS communication technique such as ARIB STD T95 or PHS MoU is employed, and wireless communication based on a TDD (Time Division Duplex)/OFDMA (or TDD/OFDM) system is conducted between the PHS terminals 110 and the base stations 120. In this embodiment, deterioration of communication quality of an anchor channel, which transmits control information such as MCS (Modulation and Coding Scheme), a map of a communication channel, or error information in this wireless communication, is detected, and the channel assignment is switched. Meanwhile, in this embodiment, descriptions are based on ARIB STD T95, PHS MoU, or others. However, the present invention can be applied to any communication method adopting an OFDMA system. Further, time division may not be performed.

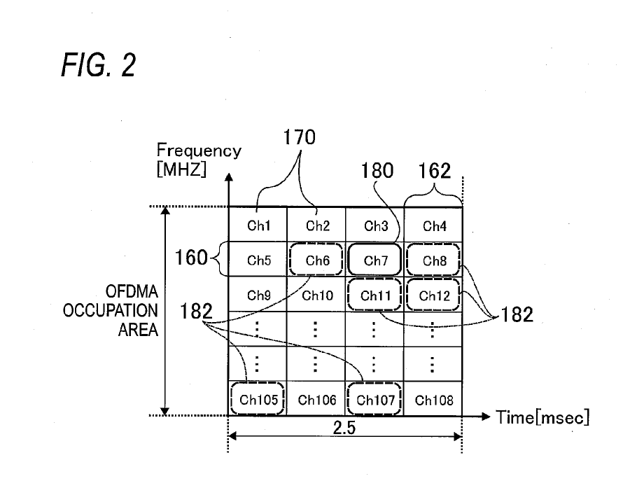

FIG. 2 is a view for explaining frame configuration of data to be transmitted and received in PHS MoU. In OFDMA (or OFDM), a two-dimensional map with time axis direction and a frequency axis direction is provided, a plurality of channels 160 are arranged in the frequency axis direction with a constant base band distance, and PRU 170 is provided for each TDMA slot 162 in each channel 160.

Accordingly, PRU 170 is defined by an occupation band of 900 kHz according to the base band distance and the duration of 625 nsec by time division. In addition, a frame used in the particular PHS terminal 110 is composed of an anchor channel (ANCH) 182 related to a control signal and an extra channel (EXCH) 182 which stores data.

The anchor channel 180 is a control signal of FM-Mode and includes, for example, MI (Mcs Indicator), MR (Mcs Requirement), an ACK field, and a map. Here, MI represents an MCS identifier of MCS when data is modulated. MR is MCS requirement of data which is transmitted to itself. From a time standpoint, MI represents MCS used for modulation of data, which are transmitted at the same time with the MCS identifier described above, and MR represents desired MCS at the next time or later. The ACK field represents results of error detection of demodulated data. A map is provided only in a frame of transmission from the base station 120 to the PHS terminal 110 and represents assignment of the extra channel 182.

The extra channel 182 is PRU 170 allocated for each user as a communication path in an FM-Mode and plural PRU 170 may be assigned to one PHS terminal 110 as indicated by dashed lines in FIG. 2. Assignment of such an extra channel 182 is performed through carrier sense for determining whether or not PRU 170 is being used by other users. Results of the assignment are shown in a map of the anchor channel 180 as described above.

Hereinafter, detailed configuration of the base station 120 and the PHS terminal 110 in the wireless communication system 100 will be described.

(Base Station 102)

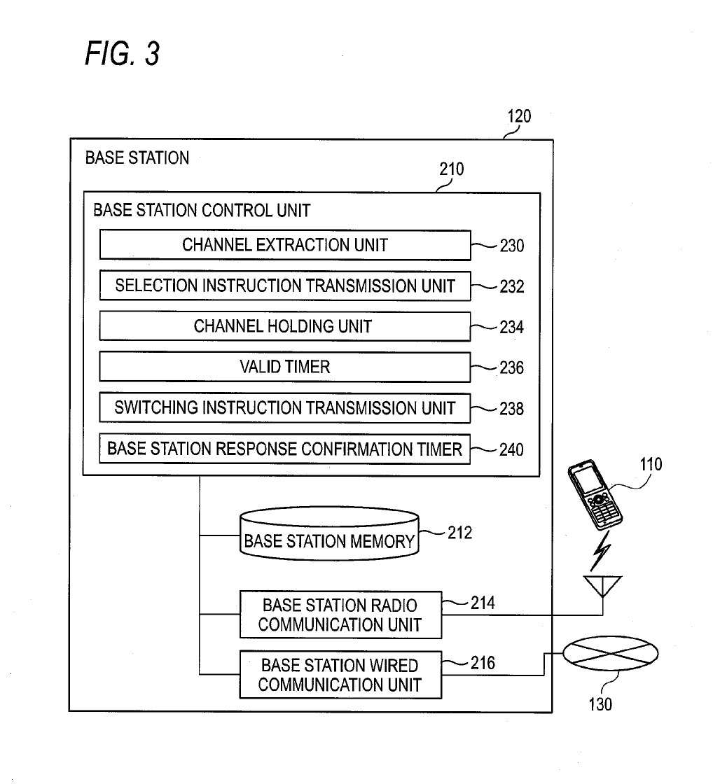

FIG. 3 is a block diagram showing general configuration of the base station 120. The base station 120 includes a base station control unit 210, a base station memory 212, a base station wireless communication unit 214, and a base station wired communication unit 216.

The base station control unit 210 manages and controls the whole base station 120 by means of a semiconductor integrated circuit including a central processing unit (CPU). In addition, the base station control unit 210 controls communication connection to the communication network 130 of the PHS terminal 110 or other PHS terminals 110 by using a program of the base station memory 212.

The base station memory 212 is configured by a ROM, RAM, EEPROM, non-volatile RAM, flash memory, HDD (Hard Disk Drive), or the like, and stores programs processed in the base station control unit 210, and time information, etc.

The base station wireless communication unit 214 establishes communication with the PHS terminal 110 and performs transmitting and receiving data. In addition, the unit 214 may determine optimum MCS to perform communication with high efficiency in accordance with quality of communication with the PHS terminal 110 and request to the PHS terminal 110 through the anchor channel 180.

The base station wired communication unit 216 may access various servers including the relay server 140 through the communication network 130.

In this embodiment, the base station control unit 210 also functions as a channel extraction unit 230, a selection instruction transmission unit 232, a channel holding unit 234, a valid timer 236, a switching instruction transmission unit 238, and a base station response confirmation timer 240.

The channel extraction unit 230 always checks communication quality of an anchor channel, and if communication quality of the anchor channel becomes a first threshold value or lower, which is a prior stage of the anchor channel for requiring switching of the anchor channel, the channel extraction unit 230 extracts through carrier sense one or a more of switching channel candidates capable of performing wireless communication with the PHS terminal 110. Here, carrier sense is performed based on SINR (Signal to Interference and Noise Ratio) or a bit error rate in each channel (PRU) of a frame, in which transmitting and receiving with the PHS terminal 110 are performed.

The selection instruction transmission unit 232 allows a switching channel selection instruction to include the one or more of switching channel candidates extracted by the channel extraction unit 230, and transmits the switching channel selection instruction to the PHS terminal 110. In this case, in order to transmit the switching channel candidates to the PHS terminal 110, CQI Report Indication prepared in advance in PHS MoU may be used.

CQI Report Indication is originally a command for measurement of communication quality of the PHS terminal 110 and used to search whether or not the anchor channel selected by the base station 120 maintains the communication quality in the PHS terminal 110 as well. By using such CQI Report Indication, it is possible to avoid addition of new software and transmission a plurality of switching channel candidates to the PHS terminal 110.

The channel holding unit 234 receives a selection response transmitted by the channel selection unit 330 of the PHS terminal 110 in response to the switching channel selection instruction, which will be described later, and extracts and holds the switching channel included in this selection response.

The valid timer 236 measures valid time of the switching channel held in the channel holding unit 234, namely, lapse of a set predetermined time period after the switching channel is held in the channel holding unit 234. By virtue of such a valid timer 236, a valid time period can be provided for the selected switching channel, and if communication quality is still the first threshold value or lower even after time-out of the valid timer 236, an optimum switching channel at that time can be selected once again. Thus, it is possible to continuously renew an actually available switching channel, irrespective of changes in wireless wave environment. The valid timer 236 is also stopped by recovery from the first threshold value, a channel switching instruction, or an anchor channel switching request, which will be described in a Second Embodiment.

If the communication quality of the anchor channel becomes a second threshold value or lower, which is lower than the first threshold value, the switching instruction transmission unit 238 transmits, to the PHS terminal 110, a channel switching instruction to switch the anchor channel to the switching channel held in the channel holding unit 234.

The base station response confirmation timer 240 starts count from the time when the switching instruction transmission unit 238 transmits the channel switching instruction. And, the timer 240 becomes time out if there is no response from the PHS terminal 110, regardless of the transmission of the channel switching instruction, and stops the channel switching process to continue the communication through the previous channel. In this way, wireless communication is at least continued.

(PHS Terminal 110)

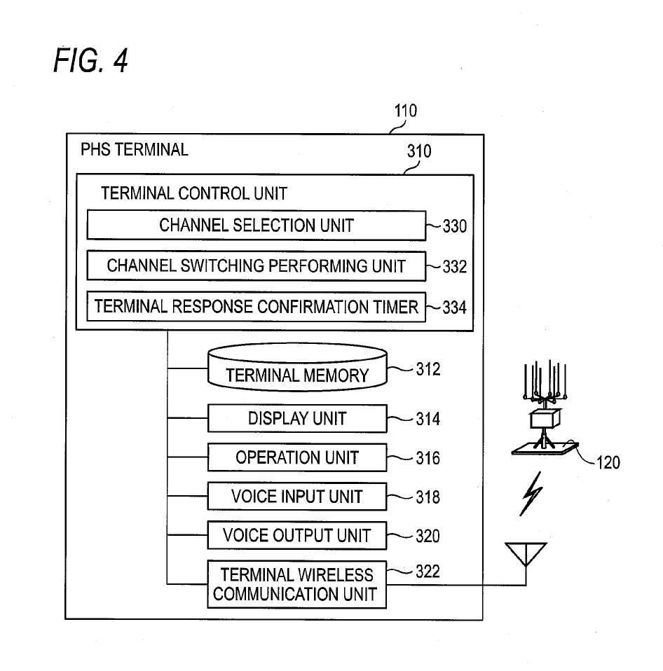

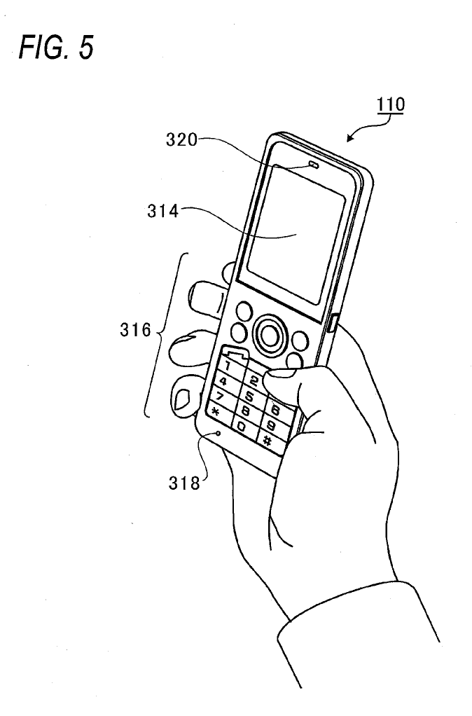

FIG. 4 is a functional block diagram showing hardware configuration of the PHS terminal 110. FIG. 5 is a perspective view showing appearance of the PHS terminal 110. The PHS terminal 110 includes a terminal control unit 310, a terminal memory 312, a display unit 314, an operation unit 316, a voice input unit 318, a voice output unit 320, and a terminal wireless communication unit 322.

The terminal control unit 310 manages and controls the whole PHS terminal 110 by means of a semiconductor integrated circuit including a central processing unit (CPU). In addition, the terminal control unit 310 also performs call function, mail transmitting and receiving function, imaging function, music playing function, and TV viewing function by using a program of the terminal memory 312.

The terminal memory 312 is configured by a ROM, RAM, EEPROM, non-volatile RAM, flash memory, HDD, or the like, and stores programs processed in the terminal control unit 310, and voice data, etc.

The display unit 314 is configured by a liquid crystal display, EL (Electro Luminescence), and so on, and can display Web Browser or GUI (Graphical User Interface) of application, stored in the terminal memory 312 or provided from an application relay server (not illustrated) through the communication network 130.

The operation unit 316 is configured by switches such as a keyboard, a cross key, and a joystick, and accepts user's operation input.

The voice input unit 318 is configured by voice recognition means such as a microphone, and converts user's voice input during call into an electric signal, which can be processed in the PHS terminal 110.

The voice output unit 320 is configured by a speaker and converts call counterpart's voice signal received in the PHS terminal 110 into voice to output it. In addition, the unit 320 can output ringtones, operation sound of the operation unit 316, and alarm sound, etc.

The terminal wireless communication unit 322 establishes wireless communication with the base station 120 in the communication network 130 to transmit and receive data.

In addition, in this embodiment, the terminal control unit 310 also functions as a channel selection unit 330, a channel switching performing unit 332, and a terminal response confirmation timer 334.

In response to the switching channel selection instruction from the base station 120, the channel selection unit 330 performs carrier sense for the one or more of switching channel candidates included in the switching channel selection instruction, selects a switching channel which is capable of performing wireless communication with the base station 120 and has the highest communication quality, and allows a selection response to include the selected switching channel to transmit it to the base station 120. In this case, in order to transmit the switching channel to the base station 120, CQI Report prepared in advance in PHS MoU may be used. Meanwhile, the channel selection unit 330 may not select a channel having the highest communication quality as a switching channel if the channel is capable of performing wireless communication with the base station 120.

CQI Report is originally a response signal for returning results for a communication quality measurement request of CQI Report Indication. By using such CQI Report, like CQI Report Indication, it is possible to avoid addition of new software and transmit the switching channel to the base station 120, without departing from conventional standards.

In response to the channel switching instruction from the base station 120, the channel switching performing unit 332 performs channel switching into the switching channel included in the channel switching instruction.

The terminal response confirmation timer 334 starts count from the time when the switching instruction transmission unit 238 receives the channel switching instruction from the base station 120, and if there is no response from the base station 120, the terminal response confirmation timer 334 becomes time out to stop the channel switching process and continue the communication through the previous channel.

According to the configuration of the PHS terminal 110 and the base station 120, a switching destination candidate (switching channel) of an anchor channel is selected at the time when communication quality becomes the first threshold value or lower, which is a prior stage of the second threshold value requiring switching of the anchor channel. And, if the communication quality becomes the second threshold value or lower, the anchor channel can be immediately switched. Accordingly, carrier sense is performed at non-congested (always or periodical) appropriate timing, so that increase of processing load or consumed power is inhibited, and the switching process of the anchor channel is completed within a short time period. As a result, a new anchor channel is established earlier, and thereby improving efficiency and stability of wireless communication.

In addition, in selecting a switching channel, the base station 120 can extract a plurality of switching channel candidates capable of performing wireless communication. Among the candidates, the PHS terminal 110 can select a switching channel. As such, the chance to select an appropriate switching channel can be greatly increased, compared to conventional technology, in which the PHS terminal 110 determines whether or not to adopt one channel selected by the base station 120.

Subsequently, a wireless communication method of switching assignment of an anchor channel according to deterioration of communication quality of the anchor channel by using the PHS terminal 110 or the base station 120 described above will be described.

(Wireless Communication Method)

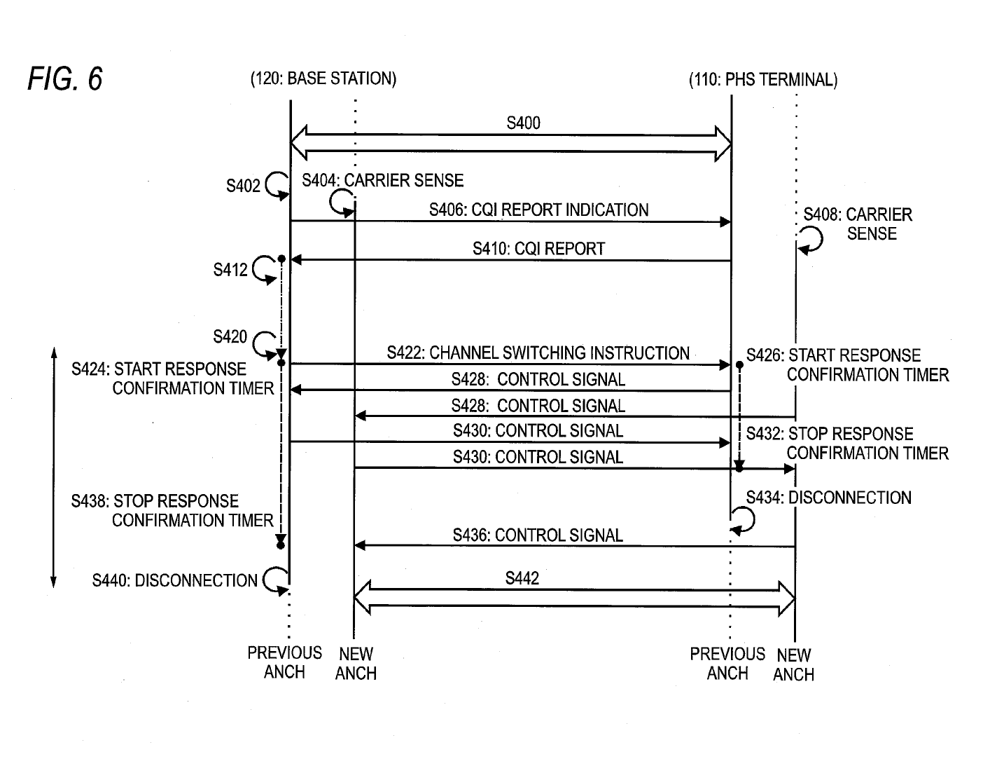

FIG. 6 is a sequence view showing a flow of processes of the wireless communication method. The PHS terminal 110 performs communication through an anchor channel provided in a channel designated by SCCH (Signaling Control Channel) from the base station 120, and an extra channel designated through the anchor channel (S400). Here, if the base station 120 detects that the communication quality of the anchor channel becomes the first threshold value or lower (S402), the base station 120 performs carrier sense for all channels capable of performing communication to extract one or more of switching channel candidates capable of performing wireless communication with the PHS terminal 110 (S404). And, the base station 120 transmits a switching channel selection instruction (CQI Report Indication) including the switching channel candidates to the PHS terminal 110 through EDCH (EXCH Data Channel) (S406).

In response to the switching channel selection instruction from the base station 120, the PHS terminal 110 performs carrier sense for the switching channel candidates (S408), and transmits to the base station 120 a selection response (CQI Report) including a switching channel, which is capable of performing wireless communication with the base station 120 and has the highest communication quality (S410). Meanwhile, as described above, the switching channel may not be a channel having the highest communication quality if it is capable of performing wireless communication with the base station 120.

The base station 120 receives the selection response from the PHS terminal 110, holds the switching channel included in the selection response, and starts count of the valid timer 236 (S412).

If the base station 120 detects that the communication quality of the anchor channel becomes the second threshold value or lower (S420), the base station 120 transmits a channel switching instruction including the held switching channel to the PHS terminal 110 (S422). And, in the base station 120, count of the base station response confirmation timer 240 is started simultaneously with the transmission of the channel switching instruction.

Upon receiving the channel switching instruction, the PHS terminal 110 starts count of the terminal response confirmation timer 334 (S426), similar to the base station response confirmation timer, and starts uplink transmission of the switching channel included in the channel switching instruction as a new anchor channel and the previous anchor channel by means of the same control signal (S428).

Upon receiving the control signal through the new anchor channel and the previous anchor channel, like the PHS terminal 110, the base station 120 starts downlink transmission by means of the same control signal as the new anchor channel and the previous anchor channel (S430).

Upon receiving the downlink control signal of the new anchor channel and the previous anchor channel, the PHS terminal 110 concludes that downlink synchronization has been established, and stops the PHS terminal response confirmation timer 334 (S432). And, the PHS terminal 110 disconnects and opens the previous anchor channel (S434) and transmits that to the base station 120 through the new anchor channel (S436).

Upon receiving this, the base station 120 concludes that uplink synchronization has been established, and stops the base station response confirmation timer 240 (S438). And, the base station 120 disconnects and opens the previous anchor channel (S440). In this way, communication through the new anchor channel is established (S442).

According to the wireless communication method, the time period (indicated by a two-direction bold arrow in the drawings) from when the base station 120 detects deterioration (less than a second threshold value) of communication quality until the channel is completely changed over is dramatically reduced.

In addition, the switching channel selection instruction, the selection response, the channel switching request, or the channel switching instruction described above are transmitted through an extra channel. An MAC frame of an extra channel also has an area for storing this control signal.

### Second Embodiment

In the above-described embodiment, the base station 120 detects deterioration of the communication quality. In this embodiment, however, the PHS terminal 110 detects deterioration of the communication quality. Thus, a node itself, which detects deterioration of communication quality, can start preparation for switching of an anchor channel. As such, a node having poor communication quality, namely, a node actually requiring anchor channel switching can pull the trigger.

(PHS Terminal 110 and Base Station 120)

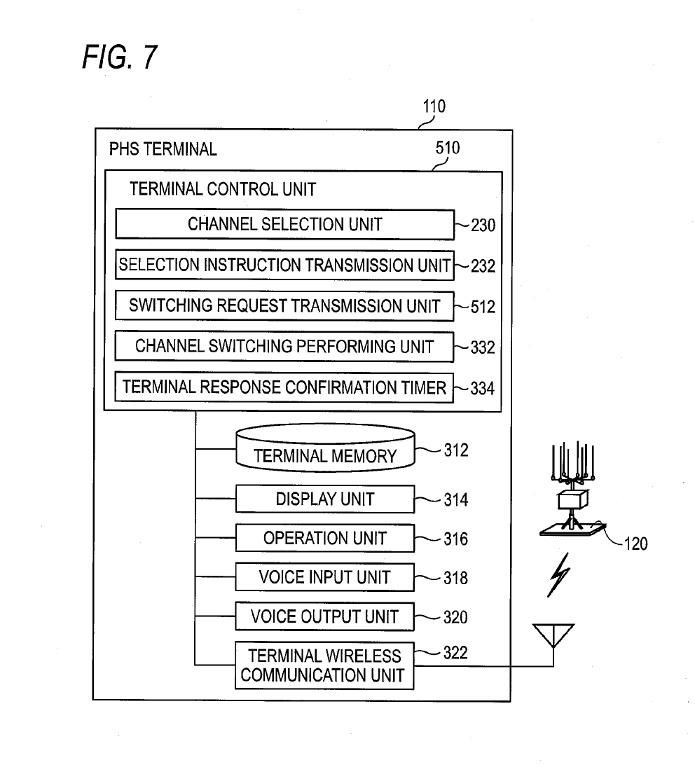

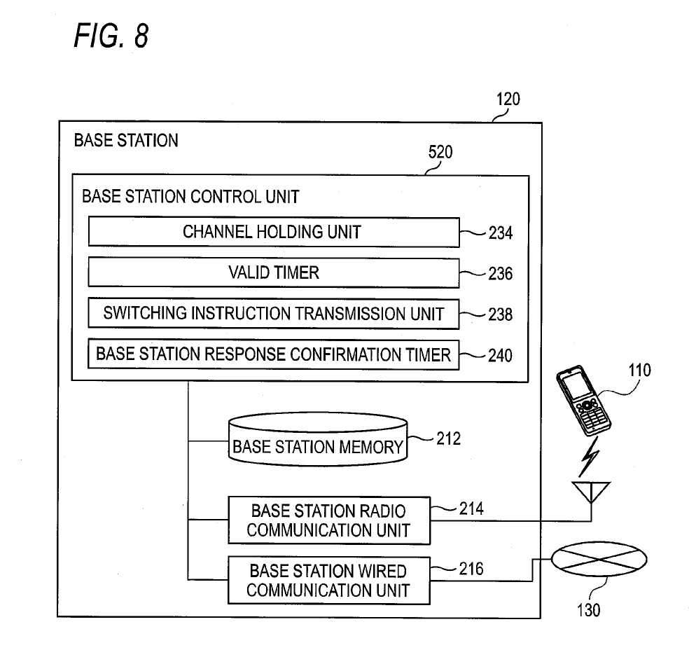

FIG. 7 is a block diagram showing general configuration of the PHS terminal 110. FIG. 8 is a block diagram showing general configuration of the base station 120. The PHS terminal 110 includes a terminal control unit 510, a terminal memory 312, a display unit 314, an operation unit 316, a voice input unit 318, a voice output unit 320, and a terminal wireless communication unit 322. In addition, in this embodiment, the terminal control unit 510 also functions as the channel extraction unit 230, the selection instruction transmission unit 232, the switching request transmission unit 512, the channel switching performing unit 332, and the terminal response confirmation timer 334.

The base station 120 includes a base station control unit 520, a base station memory 212, a base station wireless communication unit 214, and a base station wired communication unit 216. In addition, in this embodiment, the base station control unit 520 also functions as the channel holding unit 234, the valid timer 236, the switching instruction transmission unit 238, and the base station response confirmation timer 240.

In the components described in the First Embodiment, some have different node devices. However, since they have substantially the same functions, their overlapping descriptions are omitted. Herein, only a switching request transmission unit 512, which has different configuration, will be described. Explanation of other detailed differences is substituted by the flow charts set forth below.

In this embodiment, the base station 120 holds the switching channel of the anchor channel and also outputs the channel switching instruction. Thus, even if the PHS terminal 110 detects deterioration of the communication quality and has pulled the trigger, the channel switching instruction are finally made by the base station 120. If communication quality of the anchor channel becomes the second threshold value or lower, the switching request transmission unit 512 transmits a channel switching instruction to the base station 120 by transmitting a request for channel switching of the anchor channel to the base station 120.

(Wireless Communication Method)

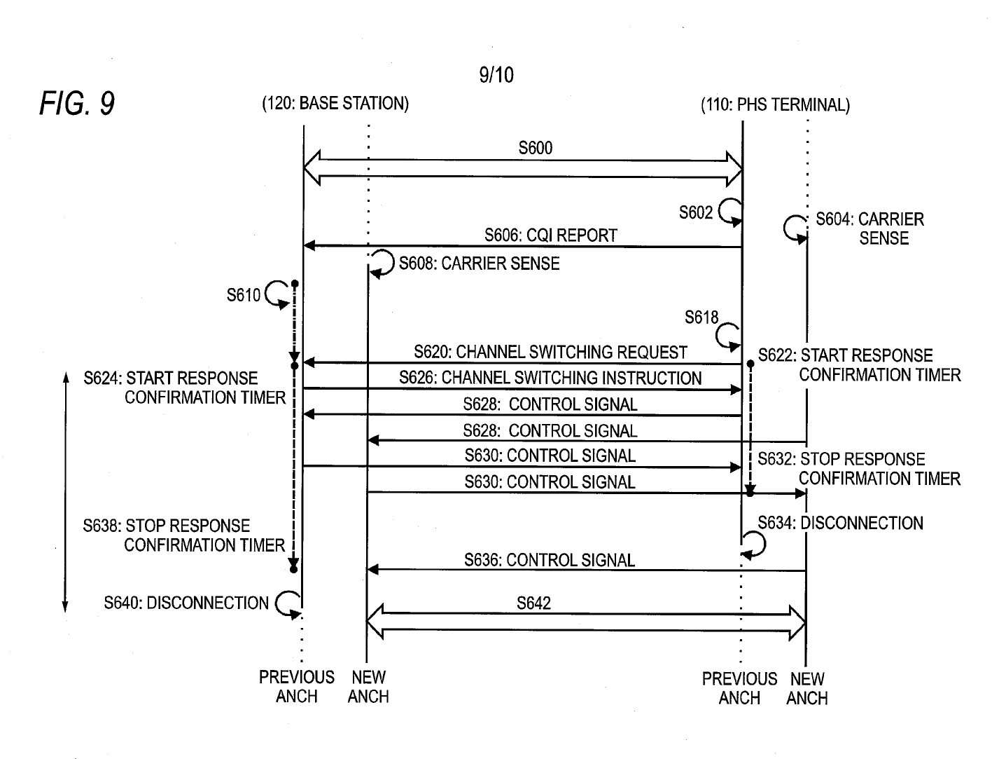

FIG. 9 is a sequence view showing a flow of processes of the wireless communication method. The PHS terminal 110 performs communication through an anchor channel provided in a channel designated by SSCH (Signaling Control Channel) from the base station 120, and an extra channel designated through the anchor channel (S600). Here, if the PHS terminal 110 detects that communication quality of the anchor channel becomes the first threshold value or lower (S602), the PHS terminal 110 performs carrier sense to extract one or more of switching channel candidates capable of performing wireless communication with the base station 120 (S604). And, the PHS terminal 110 transmits a switching channel selection instruction (CQI Report) including the switching channel candidates to the base station 120 through EDCH (EXCH Data Channel) (S606).

The base station 120 performs carrier sense for the switching channel candidates in accordance with the switching channel selection instruction from the PHS terminal 110 (S608) and holds a switching channel capable of performing wireless communication with the PHS terminal 110 and having the highest communication quality. And, the base station 120 starts count of the valid timer 236 (S610). Meanwhile, the switching channel may not be a channel having the highest communication quality if it is capable of performing wireless communication with the PHS terminal 110.

And, if the PHS terminal 110 detects that communication quality of the anchor channel becomes the second threshold value or lower (S618), the PHS terminal 110 transmits a channel switching request to the base station 102 (S620). In addition, in the PHS terminal 110, count of the terminal response confirmation timer 334 is started simultaneously with the transmission of the channel switching request (S622).

Upon receiving the anchor channel switching request, the base station 120 starts count of the base station response confirmation timer (S624), like the terminal response confirmation timer, and transmits a channel switching instruction to the PHS terminal 110 (S626). The PHS terminal 110 starts uplink transmission of the switching channel presented in the channel switching instruction from the base station 120 as an anchor channel together with the previous anchor channel by means of the same control signal.

Upon receiving the control signal through the new anchor channel and the previous anchor channel, like the PHS terminal 110, the base station 120 starts downlink transmission by means of the same control signal as the new anchor channel and the previous anchor channel (S630).

Upon receiving the downlink control signal of the new anchor channel and the previous anchor channel, the PHS terminal 110 concludes that downlink synchronization has been established, and stops the PHS terminal response confirmation timer 334 (S632). And, the PHS terminal 110 disconnects and opens the previous anchor channel, and transmits that to the base station (S636).

Upon receiving this, the base station 120 concludes that uplink synchronization has been established, and stops the base station response confirmation timer 240 (S638). And, the base station 120 disconnects and opens the previous anchor channel (S640). In this way, communication through the new anchor channel is established (S642).

According to this wireless communication method, the time period (indicated by a two-direction bold arrow in the drawings) from when the PHS terminal 110 detects deterioration (the second threshold value or lower) of the communication quality until the channel is completely switched is dramatically reduced.

As described in the First Embodiment and the Second Embodiment, a node itself, which detects deterioration of the communication quality, performs switching an anchor channel, and thereby completing a switching process of an anchor channel within a short time period, so that efficiency and stability of wireless communication can be improved.

As described, while the preferable embodiment of the present invention has been described with reference to the accompanying drawings, it goes without saying that the present invention is not limited to the embodiment. It is apparent to one skilled in the art that various modifications and changes can be made within the scope set forth in the claims, and it should be understood that such modifications and changes fall under the technical scope of the present invention.

In the embodiments described above, a particular component functions as the base station control unit 210 or a terminal control unit 310. However, this component is not limited to such case, and may be configured by hardware, for example, in the base station wireless communication unit 214, the terminal wireless communication unit 322, or the like.

In addition, in the embodiments described above, an identical node determines the first threshold value and the second threshold value. However, the determining subject is not limited thereto, and the base station 120 and the PHS terminal 110 may determine the first threshold value and the second threshold value, respectively, and vice versa.

Meanwhile, steps in the wireless communication method described in this specification do not need to be sequentially performed in the order described in the sequence views and may be performed in parallel or by subroutine.

The present application is based on Japanese Patent Application No. 2008-085142, filed on Mar. 28, 2008, the disclosures of which are herein incorporated by reference.

### INDUSTRIAL APPLICABILITY

The present invention is applicable to a wireless communication method and a wireless communication system which switch assignment of a control channel (anchor channel) for transmitting control information according to deterioration of communication quality of the control channel in a wireless communication using an OFDMA system, for example, based on PHS MoU.

1. A wireless communication method of switching assignment of a control channel for transmitting control information according to deterioration of communication quality of the control channel, in a wireless communication system including a mobile station and a base station performing wireless communication with the mobile station based on an OFDMA system, the method comprising:
the base station extracting through carrier sense one or more of switching channel candidates capable of performing wireless communication with the mobile station if the communication quality of the control channel becomes a first threshold value or lower;
the base station transmitting a switching channel selection instruction including the switching channel candidates to the mobile station;
the mobile station performing carrier sense for the one or more of switching channel candidates in response to the switching channel selection instruction from the base station;
the mobile station transmitting a selection response including a switching channel capable of performing wireless communication with the base station, to the base station;
the base station receiving the selection response from the mobile station and holding the switching channel included in the selection response;
the base station transmitting a channel switching instruction to switch the control channel to the switching channel, to the mobile station if the communication quality of the control channel becomes a second threshold value or lower, which is lower than the first threshold value; and
the mobile station switching the control channel to the switching channel in response to the channel switching instruction from the base station.

2. The wireless communication method according to claim 1,
wherein from the one or more of switching channel candidates, the mobile station selects a channel capable of performing wireless communication with the base station and having the highest communication quality, as the switching channel.

3. A wireless communication method of switching assignment of a control channel for transmitting control information according to deterioration of communication quality of the control channel, in a wireless communication system including a mobile station and a base station performing wireless communication with the mobile station based on an OFDMA system, the method comprising:
the mobile station extracting through carrier sense one or more of switching channel candidates capable of performing wireless communication with the base station if the communication quality of the control channel becomes a first threshold value or lower;
the mobile station transmitting a switching channel selection instruction including the one or more of switching channel candidates to the base station;
the base station performing carrier sense for the switching channel candidates in response to the switching channel selection instruction from the mobile station, and holding a channel capable of performing wireless communication with the mobile station as a switching channel;
the mobile station transmitting a request for channel switching of the control channel to the base station if the communication quality of the control channel becomes a second threshold value or lower, which is lower than the first threshold value;
the base station transmitting a channel switching instruction to switch the control channel to the switching channel to the mobile station in response to the channel switching request; and
the mobile station switching the control channel to the switching channel in response to the channel switching instruction from the base station.

4. The wireless communication method according to claim 3,
wherein from the one or more of switching channel candidates, the base station selects a channel capable of performing wireless communication with the mobile station and having the highest communication quality, as the switching channel.

5. The wireless communication method according to claim 1,
wherein the mobile station and the base station perform wireless communication based on PHS MoU using an OFDMA system, and
wherein the control channel is an anchor channel.

6. A wireless communication system comprising:
a mobile station; and
a base station performing wireless communication with the mobile station based on an OFDMA system, and the wireless communication system being configured to switch assignment of a control channel according to deterioration of communication quality of the control channel,
wherein the base station includes:
a channel extraction unit which extracts through carrier sense one or more of switching channel candidates capable of performing wireless communication with the mobile station if the communication quality of the control channel becomes a first threshold value or lower;
a selection instruction transmission unit which transmits a switching channel selection instruction including the one or more of switching channel candidates, to the base station;
a channel holding unit which receives a selection response from the mobile station and holds a switching channel included in the selection response; and
a switching instruction transmission unit which transmits a channel switching instruction to switch the control channel to the switching channel, to the mobile station if the communication quality of the control channel becomes a second threshold value or lower, which is lower than the first threshold value, and wherein the mobile station includes:
a channel selection unit which performs carrier sense for the switching channel candidates in response to the switching channel selection instruction from the base station and transmits the selection response including the switching channel capable of performing wireless communication with the base station, to the base station; and
a channel switching performing unit which switches the control channel to the switching channel in response to the channel switching instruction from the base station.

7. The wireless communication system according to claim 6,
wherein the channel selection unit selects a channel capable of performing wireless communication with the base station and having the highest communication quality, as the switching channel.

8. A wireless communication system comprising:
a mobile station; and
a base station performing wireless communication with the mobile station based on an OFDMA system, and the wireless communication system being configured to switch assignment of a control channel according to deterioration of communication quality of the control channel,
wherein the mobile station includes:
a channel extraction unit which extracts through carrier sense one or more of switching channel candidates capable of performing wireless communication with the base station if the communication quality of the control channel becomes a first threshold value or lower;
a selection instruction transmission unit which transmits a switching channel selection instruction including the switching channel candidates to the base station;
a switching request transmission unit which transmits a request for channel switching of the control channel, to the base station if the communication quality of the control channel becomes a second threshold value or lower, which is lower than the first threshold value; and
a channel switching performing unit which switches the control channel to the switching channel included in the channel switching instruction in response to the channel switching instruction from the base station, and wherein the base station includes:
a channel holding unit which performing carrier sense for the switching channel candidates in response to the switching channel selection instruction from the mobile station, and holds a channel capable of performing wireless communication with the mobile station, as the switching channel, and
a switching instruction transmission unit which transmits a channel switching instruction to switch the control channel to the switching channel to the mobile station in response to the request for channel switching.

9. The wireless communication system according to claim 8,
wherein from the one or more switching channel candidates, the channel holding unit holding a channel capable of performing wireless communication with the mobile station and having the highest communication quality, as the switching channel.

10. The wireless communication system according to claim 6,
wherein the base station further includes a valid timer which determines a lapse of valid time of the switching channel held in the channel holding unit.

11. The wireless communication system according to claim 6,
wherein the mobile station and the base station perform wireless communication based on PHS MoU adopting an OFDMA system, and the control channel is an anchor channel.

12. The wireless communication system according to claim 11, wherein the switching channel selection instruction, the selection response, the channel switching request, or a channel switching instruction are transmitted through an extra channel.
